(19) United States
(12) Patent Application Publication
(10) Pub. No.: US 2002/0001140 A1
(43) Pub. Date: Jan. 3, 2002

(54) Collecting and organizing means for multiple light sources

(75) Inventor: Richard J. Heimer, Los Angeles, CA (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(73) Assignee: Radiant Optics, Inc.

(21) Appl. No.: 09/934,199

(22) Filed: Aug. 21, 2001

Related U.S. Application Data
(63) Continuation of application No. 09/448,860, filed on Nov. 23, 1999.

(51) Int. Cl. G02B 3/02; G02B 13/18

(52) U.S. Cl. 359/719; 359/708

(57) ABSTRACT

A positive-powered lens for collecting and organizing the light output from a plurality of light sources into a single secondary source that has an anterior surface, upon which are disposed light-collecting tessellates that are arranged in an ordered geometrical (e.g., a square, rectangular, circular, or oval) pattern surface, and a posterior surface that is convex. The tessellates can have a common surface equation a different surface equation but equivalent focal lengths. The tessellates are associated with a plurality of light sources, each having a proximal face that is coplanar with the focal planes of the tessellates.

### BACKGROUND OF THE INVENTION

a) Field of the Invention

The present invention relates generally to fiber optics lighting systems and, specifically, to a fiber optics illumination device employing a plurality of light-emitting diodes (LEDs), said LEDs arranged in a spaced and ordered geometrical organization, and a single optical element, for example, a lens, for collecting light from said LEDs, and distributing said light to a common exit pupil. Said exit pupil may serve as the secondary source of illumination for a variety of lighting needs including but not limited to fiber optics lighting and digital projection system applications.

b) Description of the Prior Art

The LED comprises a semiconductor chip, or die, inside a cylindrically shaped plastic envelope, the light-emitting end portion of which is an epoxy dome lens having a roughly elliptical or spherical surface. The die is roughly a cube 0.25 millimeters on a side that is positioned within a silver-plated reflector cup. The reflector cup, which is located at the focal plane of the dome lens, is shaped as a truncated frustum of a cone. The reflector cup and dome lens cooperate to shape the emergent luminous intensity distribution of the LED.

Single and multi-chip discrete LEDs are typically used in instrumentation applications. Frequently, optical fibers are used in conjunction with these LEDs for this purpose. FIG. 1 is a schematic that illustrates such an integrated LED driven fiber optics system 10. LED 11 is disposed within an emitter condenser housing 14, wherein its luminous intensity is focused by condenser lens 13 onto the proximal face of optical fiber 16. Condenser lens 13 may be either a one-quarter pitch gradient index lens, as manufactured by NSG America, Inc., Somerset, N.J., or a molded aspherical lens, as manufactured by Geltech, Inc., Alachua, Fla. Optical fiber 16 is typically a plastic fiber consisting of an inner acrylic (polymethyl methacrylate) core coated with an evaporated thin film cladding of fluorinated polymer.

The proximal end portion of fiber 15 is supported by end connector means 16, positioning the fiber-input face at the focus of lens 13. The distal end portion of the said fiber is similarly supported by end connector means 18, which is, in turn, attached to panel 20. The distal output face of fiber 16 cooperates with end-fitting lens 17 to favorably distribute the emerging light to suit its intended application.

LEDs are also employed in industrial and automotive applications as packaged products, which directly replace incandescent lamps for brighter, longer and less expensive operation. Packaged products are typically arranged in clusters wherein a plurality of LEDs is arranged in an ordered, geometrical pattern, as schematically illustrated in FIG. 2a and FIG. 2b. Referring to FIG. 2a, packaged product 32 consists of a light emitting end portion and, disposed at it opposite end, an electrical socket connector 34. The light emitting end portion consists of a plurality of LEDs 11 disposed so that their respective longitudinal axes are co-parallel to each other and to the longitudinal axis of package 32. Each LED 11 emits light into a cone having an interior angle 2a, the central axis of said radiation being coincident with the longitudinal axis of said LED.

The plurality of LEDs 11 may be arranged in an ordered, geometrical pattern on proximal surface 30 of package 32, such as shown in FIG. 2a. Whereas these packaged products may be used as stand alone devices, such as, for example, in vehicular tail, turn indicator and stop light applications, it would be desirable to have a means in which to collect the respective luminous intensity of each LED and distribute same into a single aperture, or exit pupil, thus forming a low cost, high intensity light source.

There is known an application of a packaged LED product having a composition as illustrated in FIG. 3. Said known packaged LED light source 40 is composed of a plurality of light transmitting optical systems, each optical system consisting of an LED disposed on mounting board 31, a condenser lens housing assembly 14, including condenser lens 13 and fiber coupler 16, and optical fiber 15. The proximal end portions of each optical fiber 15 is disposed to receive the focused radiant energy transferred by the condenser lens 13 from conjugate LED light source 11.

Said light transmitting optical systems are arranged in an ordered, geometrical pattern conforming to the ordered, geometrical arrangement of the LEDs as laid out on the mounting board of the packaged product. The distal end portions of the plurality of fibers 15 are combined to form a closely packed incoherent fiber bundle having an application-specific cross-section 58, such as, but not limited to, a circle or a rectangle.

The aforementioned known method of collecting and organizing the radiant energy output of a packaged LED product, or a cluster of LEDs, through the use of a plurality of light transmitting optical systems, the exact number of which may correspond to the number of LEDs in said cluster, has significant drawbacks. First, the throughput luminance in each light transmitting system can be expressed as

I=I₀τ_{c}τ_{f}(1−R)⁵

where I₀ is the source illuminance, τ_{c} and τ_{f} are the selective absorptions of the condenser lens and fiber material media respectively, and R is the reflection losses at the optical surface of the system. Substituting conservative values for τ and R in the expression above, it is seen that the output illuminance of each light transmitting optical system may be reduced by as much as 45 percent of the initial source illuminance. Second, the plurality of light transmitting optical systems is considered to be cost-ineffective given the plurality of parts and the cost of labor for assembly of said parts.

Thus, there is a need for a light collecting and organizing means for packaged LED products, such as LED clusters, that is inexpensive and more energetically efficient relative to known optical systems.

### SUMMARY OF THE INVENTION

It is the object of this invention to provide a collecting and organizing means for light emitted from light emitting diodes, particularly light emitting diodes that are arranged in clusters or in packaged products. A further object of this invention is to provide an improved light collecting and organizing means having luminosity characteristics that is substantially superior to those of the convention prior art systems.

The above and other objects of this invention will become more readily apparent when the following description is read in conjunction with the accompanying drawings.

### BRIEF DESCRIPTION OF THE DRAWING

FIG. 1 is a sectional view of a light transmission optical system for a light emitting diode source;

FIG. 2a is a side view of a packaged light emitting diode product;

FIG. 2b is a plan view showing the plurality of light emitting diodes arranged in an ordered, geometrical pattern;

FIG. 3 is a sectional view of a prior art light collecting and organizing means employing a plurality of light transmitting optical systems;

FIG. 4 is a plot showing the angular light distribution characteristic, or directivity, of a typical light emitting diode;

FIG. 5 is a plot of the spectral irradiance function of a typical white light emitting diode over the visible portion of the electromagnetic spectrum;

FIG. 6 is a plot of the CIE 1931 chromaticity diagram showing the location of white light emitting diode and its color temperature;

FIG. 7 is a sectional view of the present invention showing, for purposes of explanation, the paths of principal and aperture rays, in the meridional plane, traced from two light emitting diodes disposed on opposite sides of the optical axis;

FIG. 8a is a sectional view of the collecting and organizing means of the present invention showing the light transmitting surface tesellations on the anterior surface and the convex posterior surface;

FIG. 8b is a plan view of the light transmitting surface tessellations on the anterior surface of the light collecting and organizing means of the present invention;

FIG. 9 is a sectional view of the light collecting and organizing means of the present invention showing ray tracings originating from a plurality of light emitting diodes and terminating at a common exit pupil plane.

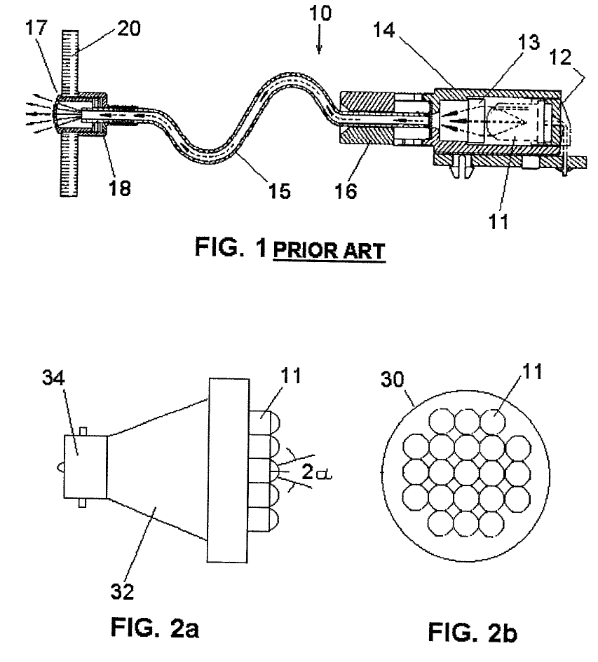

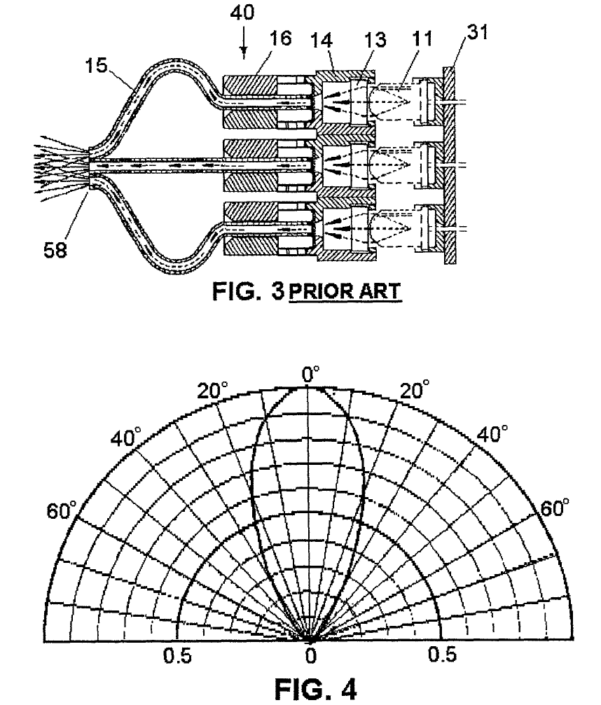

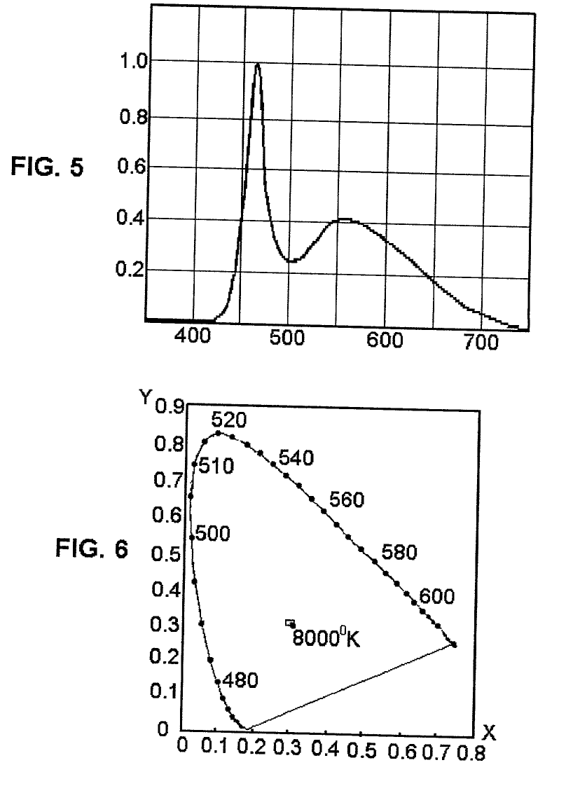

### DESCRIPTION OF THE PREFERRED EMBODIMENT

Prior to describing the present invention, pertinent optical characteristics of the light emitting diode will be discussed. It is believed that this discussion will aid in an understanding of the utility of the present invention.

The direction of light propagation of the LED is along the longitudinal axis of the device. The angular light distribution, or its directivity, is defined in terms of beam-spread propagation. The angular measures of numerical aperture (NA) and angle of field characterize beam-spread propagation. NA is defined as

NA=sin α

where α is one-half the included angle between the 50 percent power points as illustrated in FIG. 4. The angle of field β is defined as the included angle between the 20 percent power points. When <β≈<2α, the luminous intensity distribution (candela/steradian) will be uniformly distributed and the edges of the field will be sharply defined. Typically, the numerical apertures of LEDs range in value from 0.17 to 0.90. Angles of field range from 40° to 160°. In the preferred embodiment of the present invention, the LED will have a NA falling in the range of 0.50 to 0.67.

Color temperature of a light source is an important consideration, particularly when that light source is used to drive optical fibers. Selective absorption in the core of an optical fiber is by far the major contributor to overall loss in transmission efficiency. In particular, absorption losses in the blue region of the visual spectrum are much greater than in the associated yellow, green or red portions. In the case of a given length of low numerical aperture fiber, the transmission of the blue end of the spectrum is typically 34 percent as great as the transmission in the yellow middle of the spectrum.

For good color rendition, therefore, it is essential to use a light source having a high color temperature. The concept of color temperature arises from the apparent color of an object as it is heated to various temperatures. When the object is hot enough to glow it is said to be incandescent. Special classes of incandescent objects that emit radiation with 100 percent efficiency are called blackbody radiators. Specifically, an ideal blackbody glows with a color that depends only on temperature, making it an ideal color standard. Thus, by adjusting the temperature, a wide range of color sensations is produced. Color sensations are specified as blackbody temperatures in degrees Kelvin. The peak wavelength λ, in microns, of a blackbody at color temperature T may be calculated from the expression

λₘₐₓ=2897.8T⁻¹

Substituting for values of T, it is seen that the higher the color temperature the lower the wavelength. At a color temperature of 7000°K, the peak wavelength is 414 nanometers, which is near the blue end of the visible spectrum.

Referring to FIG. 5, a plot of the spectral irradiance function of a white LED, it is seen that there is a strong emission in the blue region of the visible spectrum, making it an ideal light source for fiber optics applications. The exitance of the white LED has sufficient blue color bias to compensate for the blue absorption of the optical fiber. As is seen in the CIE 1931 chromaticity diagram (FIG. 8), the white LED has a color temperature in the range of 6000° to 8000° K.

It will be appreciated that the unique optical characteristics of the LED hereinbefore described are implemented in the preferred embodiment of the present invention for the purposes of providing an inexpensive and efficient light collecting and organizing means.

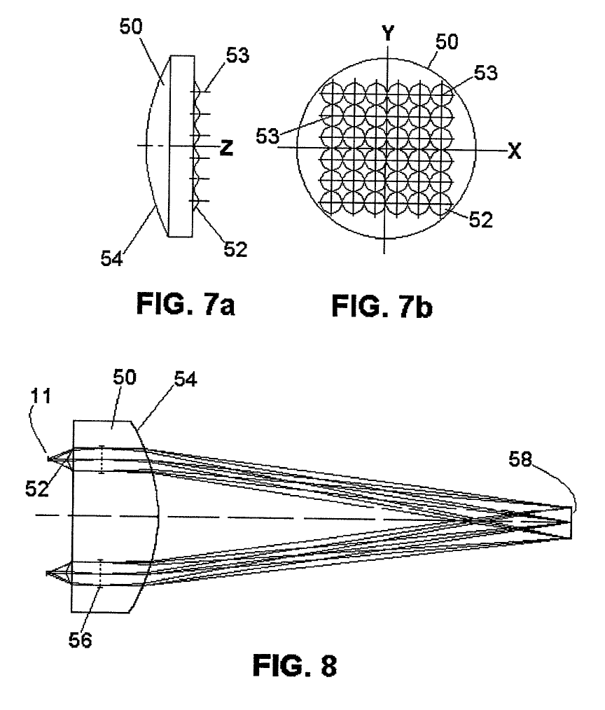

The light beam collecting and organizing lens means of the present invention consists of a positive power optical element 50 schematically illustrated in FIG. 7a. Optical element 50 is composed of an anterior surface 54 and a posterior surface 52. The material medium of optical element 50 is a borosilicate crown glass having properties suitable for thermo-plastic compression molding such as, for example, glass type B270, manufactured by Schoft Glaswerks, Mainz, Germany.

In the preferred embodiment, anterior surface 54 is a rotationally symmetric aspheric surface described by the polynomial expression

Z=cy²{1+[1−(1+k)c²y²]^{½}}⁻¹+dy⁴+ey⁶+fy⁸+gy¹⁰

where Z is the z-coordinate of the surface, c is curvature (reciprocal of the radius), y is the radial coordinate, k is the conic constant and aspheric deformation coefficients d, e, f, and g.

Posterior surface 52 is the construct of a plurality of sub-aperture refractive elements, or light transmitting tessellates, embossing said surface in a prescribed two-dimensional geometrical pattern, such as, for example, a square (FIG. 7b). Each tessellate is centered on a local optical axis, said axis being co-parallel to the global optical axis of lens 50. Said tessellates all have positive optical power and are juxtaposed in rows and columns wherein the pitch, or separation along both X- and Y-axis, may be constant. Said arrangement forms a system aperture function.

In one embodiment of the present invention, the tessellated surface consists of tessellates that are all optically identical. The optical surface of each sub-aperture tessellate is a rotationally symmetric (about its local optical axis) aspheric defined by the same polynomial expression given hereinbefore.

In another embodiment of the present invention, each tessellate need not be identical to one another, rather each tessellate may be defined by its own unique polynomial expression. Given that the aperture function of a centered optical system is bi-symmetrical about its Y-axis, the tessellation process may be simplified in that individual uniquely defined tessellates need only populate one-half of the aperture function. For example, any uniquely defined tessellate centered at an aperture coordinate (x₁, y₁) will have a corresponding, identically defined tessellate centered on the opposite aperture coordinate (−x₁, y₁).

This invention is concerned with a light collecting and organizing lens means illustrated schematically in FIG. 8 wherein, for purposes of clarity, only two tessellates are shown, each disposed on opposite sides of the Y-axis of said lens means 50 with aperture coordinates of (y_{I},0) and (−y_{I},0) respectively. Each LED 11 is longitudinally separated from surface 53 being disposed at the front focal distance of tessellate 52. The angular light distribution, or directivity, emitted from each LED 11 is collected by lens means 50 and is propagated to system focal plane 58. Surfaces 52 and 54 of lens means 50 cooperate to correct spherical aberration at surface 58.

Further, a virtual aperture stop plane 56 is formed longitudinally within the material medium of lens means 50, between surfaces 52 and 54, and positioned at a focal plane of anterior surface 52. In the said arrangement, two important benefits are derived. First, the object space between LED source 11 and light transmitting tessellate 52 is telecentric, thereby cooperating with the directivity of LED source 11 without potential loss of luminous intensity. Second, the LED 11 and exit pupil 58 are seen to be conjugates of one other. Accordingly, the luminous intensities I₁ and I₂ respectively collected by tessellates 52 disposed at coordinates (yᵢ,0) and (−y_{I},0) are propagated by lens 50 as narrow beams of radiation traveling along symmetrically separate paths about the global axis to exit pupil 58 with exactly the same magnification. These beams of radiation coincide in pupil 58 without the effects of parallax. As a result, the respective illuminance of each beam of radiation, being free of vignetting, is combined within the boundaries of exit pupil 58, essentially doubling the available luminous flux in said pupil aperture.

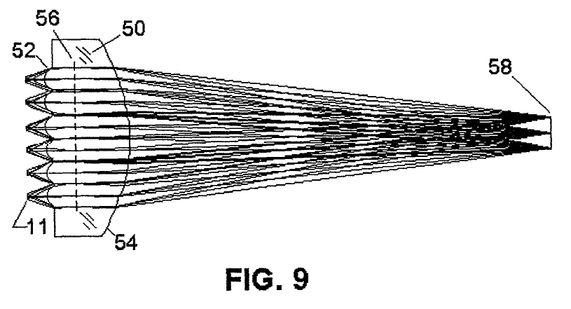

FIG. 9 is a cross-sectional view of the preferred embodiment of the present invention showing the ray paths originating from multiple LED sources 11, propagating through the light collecting and organizing means 50 and terminating at exit pupil plane 58. It will be appreciated that the luminous intensity of an LED and the number of LEDs in a given cluster determine the illuminance at exit pupil 58. In the case of a collecting and organizing means utilizing a packaged cluster of 36 LEDs, the illuminance in exit pupil 58 would be thirty-six times the contribution of a single LED. Exit pupil 58 represent a portal through which the combined irradiance of a plurality of LEDs can be transformed into a single secondary light source useful for a variety of applications, such as but not limited to, digital projection, fiber optics lighting, displays, signage, etc.

In summary, it can be seen that the present invention provides a means for collecting and organizing the light output from plurality of light sources, such as packaged LED products, to form a single secondary light source having favorable luminosity, longevity and efficiency characteristics that are not readily attainable with conventional light sources. In the preferred embodiment, the said means is accomplished by a single positive-power lens element. The salient features of the present invention include:

1. Optimum transfer of illuminance and luminous intensity;

2. Cost effectiveness in manufacture and assembly.

Apart from the luminous losses associated with Fresnel surface reflection and selective absorption of the material media of the present invention, the only appreciable loss in luminous intensity would be due to residual manufacturing errors—losses which are common to any potential lighting solution.

While the above description contains many specificities, they should not be construed as limitations on the scope of the invention, but rather as exemplifications of the preferred embodiments thereof. Many other variations are possible, for example, the geometrical pattern of tessellation, choice of refractive material, type of aspheric surface, etc. Accordingly, the scope of the invention should be determined not by the embodiments illustrated, but by the appended claims or their equivalents.

What is claimed is:

1. A positive-powered lens for collecting and organizing the light output from a plurality of light sources into a single secondary source of light, the lens having an anterior surface which is convex, the lens having a posterior surface upon which are disposed a plurality of light-converging tessellates arranged in an ordered, geometrical pattern.

2. The positive-powered lens of claim 1 wherein the plurality of light-collecting tessellates has a common surface equation.

3. The positive-powered lens of claim 1 wherein the plurality of light collecting tessellates has different surface equations.

4. The positive-powered lens of claim 1 wherein the plurality of light collecting tessellates has equivalent focal lengths.

5. The positive-powered lens of claim 1 wherein a virtual pupil plane is defined between the anterior surface and the plurality of light-converging tessellates.

6. The positive-powered lens of claim 1 wherein a virtual pupil plane is disposed confocally between the anterior surface and the plurality of light-collecting tessellates.

7. The positive-powered lens of claim 1 wherein the plurality of light-collecting tessellates have respective, telecentric, proximal object spaces.

8. The positive-powered lens of claim 7 wherein the plurality of light-collecting tessellates is associated with a plurality of light sources the number and spatial positioning of which correspond to the number and spatial positioning of the plurality of light-collecting tessellates.

9. The positive-powered lens of claim 8 wherein each light-collecting tessellate has a local optical axis and wherein each light source has a longitudinal axis which coincides with the local optical axis of a respective one of the plurality of light-collecting tessellates.

10. The positive-powered lens of claim 8 wherein each light-collecting tessellate has a focal plane wherein the focal planes of the plurality of light-collecting tessellates are coplanar, and wherein each light source has a proximal face, which is coplanar with the focal planes of the plurality of light-collecting tessellates.

11. The positive-powered lens of any one of claims 1 through 10 wherein the ordered, geometrical pattern is square, rectangular, circular or oval.

12. The positive-powered lens of any one of claims 1 through 10 wherein the ordered, geometrical pattern is square and wherein each light-collecting tessellate has a circular, square or hexagonal aperture.
